(19) United States
(12) Patent Application Publication
(10) Pub. No.: US 2021/0331451 A1
(43) Pub. Date: Oct. 28, 2021

(54) POLYPROPYLENE LAMINATED MATERIAL AND MANUFACTURING METHOD THEREOF

(71) Applicant: SAN FANG CHEMICAL INDUSTRY CO., LTD., Kaohsiung City (TW)

(72) Inventors: CHIH-YI LIN, KAOHSIUNG CITY (TW); KUO-KUANG CHENG, KAOHSIUNG CITY (TW); CHI-CHIN CHIANG, KAOHSIUNG CITY (TW); YO CHIAN JENG, KAOHSIUNG CITY (TW)

(21) Appl. No.: 17/237,374

(22) Filed: Apr. 22, 2021

(30) Foreign Application Priority Data
Apr. 22, 2020 (TW) 109113494

(51) Int. Cl. B32B 27/06; B32B 27/18

(52) U.S. Cl. CPC B32B 27/06; B32B 2323/10; B32B 27/18

(57) ABSTRACT

The present disclosure provides a laminated material including a modified polypropylene layer, a main layer, and an adhesive layer. The modified polypropylene layer includes polypropylene and anhydride-grafted polyolefin, and has an unroughened surface. The adhesive layer contacts the unroughened surface of the modified polypropylene layer and adheres to the main layer. The present disclosure further provides a method for manufacturing the laminated material.

### BACKGROUND

### 1. Field of the Disclosure

The present disclosure relates to a composite material, and more particularly to a laminated material and a manufacturing method thereof.

### 2. Description of the Related Art

In the technical field of surface materials, it is important to firmly laminate different materials together to prevent peeling of layers. Different materials, due to differences in polarity and surface roughness, are especially resistant to adhesion. The difficulty is compounded when the layers constitute leather or foaming material.

In a conventional method, when laminating different materials, especially materials of different polarities, surface processing of one of the materials is conducted to enhance adhesion. The surface processing may include physical roughening of the surface, or use of chemical treatment agents to increase surface polarity. For example, when a polypropylene foil, which is widely used in industry, is to be laminated, the surface of the polypropylene foil is modified with a primer to enhance adhesion. Then, after coating or spraying an adhesive layer on the modified surface, the polypropylene foil can be laminated to other materials. In another aspect, when a foaming material, polypropylene foil and leather is to be laminated, the production method comprises making a polypropylene foil, applying a primer onto a surface of the polypropylene foil for surface processing, applying an adhesive layer to the processed surface, laminating it to the leather, then heating the polypropylene foil and leather composite material and molding the composite material with a positive mold to obtain a desired shape, and finally forming a foaming material within the composite material. However, the processing is complicated and involves different processing areas, which makes the application very inconvenient. The aforementioned surface processing increases not only manpower and costs, but suffers further from unevenness and poor reproducibility after processing. In addition, the surface treating agents usually include chemical solvents or catalysts, and the corresponding adhesive layer may also contain components such as chlorine. These components may negatively impact the environment and present a danger to health and safety, creating multiple concerns for operators.

### SUMMARY

Hence, the present disclosure provides a laminated material which can be formed without surface processing of the conventional method for adhering layers of different materials. The manufacturing process according to the present disclosure is simple and low cost, while adhesion is enhanced. In addition, there is no need to use unsafe and environmentally unfriendly materials.

The present disclosure provides a laminated material including a modified polypropylene layer, a main layer, and an adhesive layer. The modified polypropylene layer includes polypropylene and anhydride-grafted polyolefin, and has an unroughened surface. The adhesive layer contacts the unroughened surface of the modified polypropylene layer and adheres to the main layer.

The present disclosure further provides a method for manufacturing the aforementioned laminated material, including: (a) providing the polypropylene and the anhydride-grafted polyolefin, (b) co-extruding the polypropylene and the anhydride-grafted polyolefin to form a sheet to obtain the modified polypropylene layer, (c) providing the main layer, and (d) applying the adhesive layer to contact the unroughened surface of the modified polypropylene layer and to adhere to the main layer.

### BRIEF DESCRIPTION OF THE DRAWINGS

FIG. 1 is a cross-section of a laminated material according to an embodiment of the present disclosure.

FIG. 2 is a cross-section of another laminated material according to an embodiment of the present disclosure.

### DETAILED DESCRIPTION

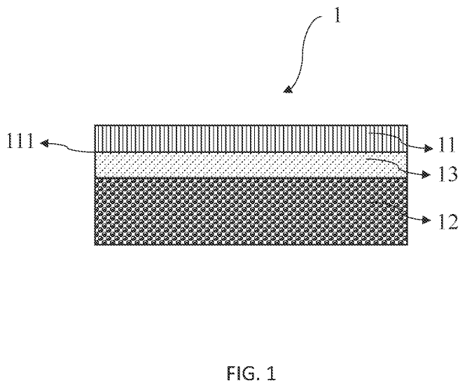

Referring to FIG. 1, a laminated material 1 according to one embodiment of the present disclosure comprises:
a modified polypropylene layer 11 comprising polypropylene and anhydride-grafted polyolefin, and having an unroughened surface 111;
a main layer 12; and
an adhesive layer 13 contacting the unroughened surface 111 of the modified polypropylene layer 11 and adhering to the main layer 12.

The laminated material of the present disclosure refers to a composite material of different material layers adhering to each other. The laminated material or the material layers may be in a sheet, film, block, or hollow block shape, but are not limited thereto.

The modified polypropylene layer of the present disclosure includes polypropylene modified with anhydride-grafted polyolefin. That is, the modified polypropylene layer includes polypropylene and anhydride-grafted polyolefin. The anhydride-grafted polyolefin is grafted by an anhydride, and the anhydride can be, but is not limited to, maleic anhydride, succinic anhydride, phthalic anhydride, butyric anhydride and acetic anhydride. Preferably, the anhydride is maleic anhydride. In a preferred embodiment of the present disclosure, the modified polypropylene layer comprises about 1% to about 10% of the anhydride-grafted polyolefin, more preferably about 5% to about 8%. In another aspect, in a preferred embodiment of the present disclosure, a grafting ratio of the anhydride-grafted polyolefin is about 0.2 mol/kg to about 2 mol/kg, more preferably about 1.0 mol/kg to about 1.8 mol/kg.

While not wishing to be bound by any theory, it is believed that since the modified polypropylene layer of the present disclosure includes the anhydride-grafted polyolefin, the anhydride functional group increases the polarity of the modified polypropylene layer. Hence, the modified polypropylene layer can provide the same adhesion strength without the need of surface processing.

In an embodiment of the present disclosure, the modified polypropylene layer may include other materials to provide appropriate physical properties according to intended use, such other polymers to provide resistance to flame, poor conductivity, weather, heat, and impact. In a preferred embodiment of the present disclosure, the modified polypropylene layer further comprises an additional thermoplastic polyolefin which is different from the polypropylene and the anhydride-grafted polyolefin. The type and quantity of the additional thermoplastic polyolefin can be adjusted according to required properties. Preferably, the additional thermoplastic polyolefin is ethylene propylene copolymer. In a preferred embodiment of the present disclosure, the modified polypropylene layer comprises about 10 wt % to about 99 wt % of the additional thermoplastic polyolefin, more preferably about 10% to about 96%. While not wishing to be bound by any theory, it is believed that the high content of thermoplastic polyolefin can provide the modified polypropylene layer with enhanced elasticity and resilience, resulting in superior molding effect in consequent molding processes.

The modified polypropylene layer 11 of the present disclosure has an unroughened surface 111. That is, the surface 111 of the modified polypropylene layer 11 has not been roughened by any surface roughening process. In the present disclosure, the surface roughening process can be, but is not limited to, physical or chemical means for increasing the roughness of a surface, such as physically forming regular or irregular holes, grooves, and nicks on the surface, or chemically etching the surface. The term “roughness” in the present disclosure is quantified by the deviations in the direction of the normal vector of a real surface from its ideal form, and can be defined by the instruments or measurement specifications commonly used in the industry. In other words, in the present disclosure, there is no need to modify the surface roughness of the modified polypropylene layer to enhance adhesion.

The main layer of the present disclosure may be any solid material. In a preferred embodiment of the present disclosure, the main layer is a foaming layer or a leather layer.

The foaming layer of the present disclosure is preferably made of a foaming resin. The “foaming resin” of the present disclosure refers to a material containing a thermoplastic resin and a thermodecomposing foaming agent. Preferably, the resin comprises at least one selected from the group consisting of polyurethane, polyolefin, polycarbonate, polyvinyl alcohol, nylon, elastic rubber, polystyrene, poly aromatic molecules, fluorine-containing polymer, polyimide, crosslinked polyurethane, crosslinked polyolefin, polyether, polyester, polyacrylate, elastic polyethylene, polytetrafluoroethene, poly (ethylene terephthalate), poly aromatic amide, polyarylalkene, polymethyl methacrylate, a copolymer thereof, a block copolymer thereof, a mixture thereof, and a blend thereof.

The resin, according the present disclosure, can undergo chemical or physical foaming, wherein chemical foaming uses an agent to generate a chemical reaction to yield gas evenly distributed in the resin composition, thus forming foaming holes. The physical foaming comprises infiltrating gas into the resin composition evenly distributed in the resin composition by stirring. In a preferred embodiment of the present disclosure, the holes are formed by filling a plurality of polymeric hollow spheres in the foaming resin. Embodiments of the hollow spheres are Expancel® 551DE40d42 (with a weight average diameter of 30 μm to 50 μm, produced by AkzoNobel) or Expancel® 551DE20d60 (with a weight average diameter of 15 μm to 25 μm, produced by AkzoNobel).

In the present disclosure, the holes may be continuous holes or independent holes. The term “continuous holes” as used herein refers to at least two connected holes similar to ant nests. The term “independent holes” as used herein refers to holes which are independent and unconnected to others. The independent holes usually have circular or elliptical cross-sections, and are spherical or oval.

The leather layer according to the present disclosure may be natural or artificial, with the natural leather comprises animal skin and processed by tanning, including but not limited to cowhide, buffalo hide, pigskin, goatskin, sheepskin, lamb skin, deerskin, kangaroo skin, chicken skin, snakeskin, ostrich skin, crocodile skin, or fish skin. The artificial leather comprises processed polymers imitating the appearance and texture of natural leather. The artificial leather according to the present disclosure can be, but is not limited to, single-layer, multilayer, or composite artificial leather. In a preferred embodiment of the present disclosure, the leather layer is artificial.

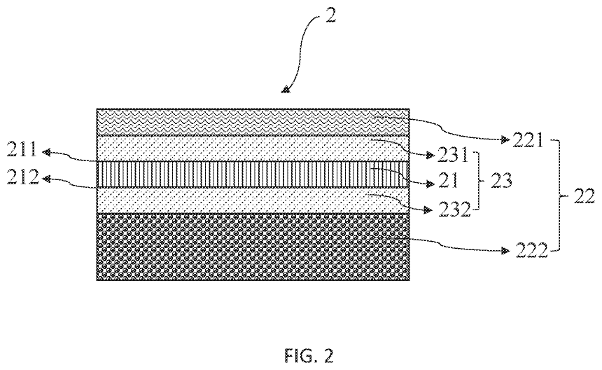

Referring to FIG. 2, a laminated material 2 according to one embodiment of the present disclosure comprises:
a modified polypropylene layer 21 having an unroughened upper surface 211 and an unroughened lower surface 212; and
a main layer 22 comprising an upper main layer 221 and a lower main layer 222, such that the modified polypropylene layer 21 is sandwiched between the upper main layer and the lower main layer; and
an adhesive layer 23 comprising an upper adhesive layer 231 and a lower adhesive layer 232 respectively contacting the unroughened upper surface 211 and the unroughened lower surface 212 of the modified polypropylene layer, and adhering to the upper main layer 221 and lower main layer 222.

In the present disclosure, material of the upper main layer may be the same as or different from that of the lower main layer. For example, the upper main layer may be leather, while the lower main layer may be a foaming layer. Alternatively, the upper main layer and the lower main layer may both be leather or foaming layers.

In the present disclosure, material of the upper adhesive layer may be the same as or different from that of the lower adhesive layer.

In a preferred embodiment of the present disclosure, the adhesive layer can be, but is not limited to, pressure-sensitive adhesive, one-part adhesive, two-part adhesive, acrylic resin, epoxy resin, or hot-melt adhesive. The pressure-sensitive adhesive generally can be a supporting film which can be, for instance, polyester. A fluid adhesive agent is coated on upper and lower sides of the supporting film. The one-part adhesive refers to an adhesive agent which utilizes an elastomer with high molecular weight for providing adhesion, preferably includes polyurethane. The one-part adhesive includes oil-modified paste and moisture-curing paste. The oil-modified paste is formed by reacting natural oil-modified or diglyceride-modified polyols with toluene diisocyanate (TDI). The moisture-curing paste includes hydroxyl-containing polyesters and polyethers, with excess NCO groups (NCO/OH>1) reacting with hydroxyl groups of toluene diisocyanate, diphenylmethane diisocyanate (MDI), hexamethylene diisocyanate (HMDI), etc., to form isocyanate-terminated prepolymers. Such isocyanate groups can react with moisture in the air to produce amines, which undergo further reactions to form urea linkage and biuret, thus forming a cured film. The two-part adhesive refers to an adhesive agent including two components which react or crosslink with each other to provide adhesion; preferably including an elastomer and polyisocyanate. The two-part adhesive may be catalyst-cured by reacting a mono-diglyceride mixture transesterified by polyethylene glycol, polypropylene glycol, or polyol with a catalyst such as tertiary amine or metal salt. The polyolcured PU paste may be formed by reacting isocyanate prepolymers and a hydroxyl group of polyol-esters or polyethers or polyols, such as hydroxyl-containing acrylic resins. The acrylic resin may be cold or dry-heat cured. The cold cured acrylic resin, which can be cured at room temperature, is essentially composed of acrylic resin monomers. The heat-dry cured acrylic resin can be acrylic resin polymers as the basic structure, with active reacting groups introduced therein. When heated, said resin, alone or with a resin containing reacting groups and crosslinking agent, reacts to form a 3D network structure. The epoxy resin can form 3D network structure with the addition of the crosslinking agent. The hot-melt adhesive can be a thermoplastic resin, which can bind the main layer and the modified polypropylene layer by softening or melting the thermoplastic polymer. In a preferred embodiment of the present disclosure, the thermoplastic resin can be, but is not limited to, thermoplastic polyurethane, thermoplastic polyester elastomer, polyolefin elastomer, or water-based paste.

In one embodiment of the present disclosure, the adhesive layer is preferably applied to the unroughened surface of the modified polypropylene layer by coating, transferring, printing, or scraping, such that the adhesive directly contacts the unroughened surface of the modified polypropylene layer and adheres the modified polypropylene layer to the main layer.

The modified polypropylene layer of the present disclosure provides favorable adhesion. Hence, there is no need to apply a chemical surface treatment (e.g., primer) on the surface of the modified polypropylene layer. The modified polypropylene layer can directly contact the adhesive layer. In comparison to the conventional method, the laminated material of the present disclosure can be formed through a simple manufacturing process at low cost. The manufacturing process according to the present disclosure is simple and low cost, while adhesion is enhanced. In addition, there is no need to use unsafe and environmentally unfriendly materials.

The present disclosure further provides a method for manufacturing the aforementioned laminated material, comprising:
(a) providing the polypropylene and the anhydride-grafted polyolefin;
(b) co-extruding the polypropylene and the anhydride-grafted polyolefin to form a sheet, to obtain the modified polypropylene layer;
(c) providing the main layer; and
(d) applying the adhesive layer to contact the unroughened surface of the modified polypropylene layer and adhere to the main layer.

In one embodiment of the present disclosure, the co-extrusion can utilize, but is not limited to, drying, melting, and co-extruding a mixture of the polypropylene, the anhydride-grafted polyolefin and other optional materials by using T-die, and then cooling the mixture to form a film of a desired thickness. In one embodiment of the present disclosure, the mixture may be pressed during co-extrusion, such as by calendar rollers, to control the thickness of the resultant film.

In one embodiment of the present disclosure, step (a) further comprises providing an additional thermoplastic polyolefin which is different from the polypropylene and the anhydride-grafted polyolefin, and step (b) comprises co-extruding the polypropylene, the anhydride-grafted polyolefin, and the polymeric material.

In one embodiment of the present disclosure, step (c) comprises providing an upper main layer and a lower main layer, and step (d) comprises applying an upper adhesive layer and a lower adhesive layer respectively to contact an unroughened upper surface and an unroughened lower surface of the modified polypropylene layer, and to adhere to the upper main layer and the lower main layer, such that the modified polypropylene layer is sandwiched between the upper main layer and the lower main layer.

The following examples are given to illustrate the method for manufacturing the conjugated fiber of the present disclosure, but are not intended to limit the scope of the present invention.

### Example 1

Drying condition: A mixture of about 77% of polypropylene, about 10% of an additional thermoplastic polyolefin (different from polypropylene and maleic anhydride-grafted polyolefin), about 10% of maleic anhydride-grafted polyolefin (maleic anhydride:polyolefin=1:9) and about 3% of additive was dried at 60° C. to a moisture content of about 300 ppm or lower.

Extruder temperature: 170° C., 210° C., 195° C.

The temperature of the T-die was set at 190° C.

The mixture was extruded and passed through calendar rollers for cooling. The speed of the calendar rollers was set at 8.0 m/min, thus forming a film having a total thickness of about 0.3 mm. The film was cured for 1 to 2 days to obtain the modified polypropylene layer.

### Example 2

Drying condition: A mixture of about 87% of polypropylene, about 10% of maleic anhydride-grafted polyolefin (maleic anhydride:polyolefin=1:9) and about 3% of additive was dried at 60° C. to a moisture content of about 300 ppm or lower.

Extruder temperature: 200° C., 230° C., 220° C.

The temperature of the T-die was set at 210° C.

The mixture was extruded and passed through calendar rollers for cooling. The speed of the calendar rollers was set at 8.0 m/min, thus forming a film having a total thickness of about 0.3 mm. The film was cured for 1 to 2 days to obtain the modified polypropylene layer.

A comparison between the modified polypropylene layer and an unmodified polypropylene layer, which is not modified with anhydride, is listed as follows.

TABLE 1

| | | Tensile | | | |
|---|---|---|---|---|---|
| | | Strengh | Elongation at | 300% stress | Tm |
| | Direction | (Kgf/cm²) | break (%) | (Kgf/cm²) | (° C.) |
| Unmodified | MD | 195 | 594 | 128 | 164 |
| | CD | 219 | 660 | 120 | |
| Modified | MD | 205 | 807 | 124 | 162 |
| | CD | 222 | 759 | 126 | |

### Example 3

A hot melt adhesive is applied on the modified propylene layer. Then, the modified propylene layer is adhered to an artificial leather by hot pressing, thus forming a laminated material. The pressure is set at 5 kg, and lasts for 36 seconds. After 1 day of curing, the laminated material is cut into 1 cm×15 cm pieces, and is tested for its peeling strength using a tensile testing machine.

The results are shown in Table 2. The adhesion strength (i.e., peeling strength) of the unmodified polypropylene layer is less than 1.2 N, while that of the modified polypropylene layer is 1.6 N or more.

TABLE 2

| | Laminating temp | Laminating temp |
|---|---|---|
| | 115° C.-135° C. | 145° C.-155° C. |
| Unmodified | No adhesion | 0.4N-1.2N |
| Modified | 0.6N | 1.6N-2.8N |

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt to a particular situation, material, composition of matter, method, or process in accordance with the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A laminated material, comprising:
a modified polypropylene layer comprising polypropylene and anhydride-grafted polyolefin, and having an unroughened surface;
a main layer; and
an adhesive layer contacting the unroughened surface of the modified polypropylene layer and adhering to the main layer.

2. The laminated material of claim 1, wherein the modified polypropylene layer further comprises an additional thermoplastic polyolefin which is different from the polypropylene and the anhydride-grafted polyolefin.

3. The laminated material of claim 1, wherein the anhydride-grafted polyolefin is grafted by an anhydride selected from the group consisting of maleic anhydride, succinic anhydride, phthalic anhydride, butyric anhydride and acetic anhydride.

4. The laminated material of claim 1, wherein the modified polypropylene layer comprises about 1% to about 10% of the anhydride-grafted polyolefin.

5. The laminated material of claim 1, wherein a grafting ratio of the anhydride-grafted polyolefin is about 0.2 mol/kg to about 2 mol/kg.

6. The laminated material of claim 2, wherein the modified polypropylene layer comprises about 10 wt % to about 99 wt % of the additional thermoplastic polyolefin.

7. The laminated material of claim 1, wherein the main layer is a foaming layer or a leather layer.

8. The laminated material of claim 1, wherein the main layer comprises an upper main layer and a lower main layer, and the modified polypropylene layer is sandwiched therebetween.

9. The laminated material of claim 1, wherein the adhesive layer includes thermoplastic resin.

10. A method for manufacturing the laminated material of claim 1, comprising:
(a) providing the polypropylene and the anhydride-grafted polyolefin;
(b) co-extruding the polypropylene and the anhydride-grafted polyolefin to form a sheet to obtain the modified polypropylene layer;
(c) providing the main layer; and
(d) applying the adhesive layer to contact the unroughened surface of the modified polypropylene layer and to adhere to the main layer.

11. The method of claim 10, wherein step (a) further comprises providing an additional thermoplastic polyolefin which is different from the polypropylene and the anhydride-grafted polyolefin, and step (b) comprises co-extruding the polypropylene, the anhydride-grafted polyolefin, and the polymeric material.

12. The method of claim 10, wherein the anhydride-grafted polyolefin is grafted by an anhydride selected from the group consisting of maleic anhydride, succinic anhydride, phthalic anhydride, butyric anhydride, and acetic anhydride.

13. The method of claim 10, wherein the modified polypropylene layer comprises about 1% to about 10% of the anhydride-grafted polyolefin.

14. The method of claim 10, wherein a grafting ratio of the anhydride-grafted polyolefin is about 0.2 mol/kg to about 2 mol/kg.

15. The method of claim 11, wherein the modified polypropylene layer comprises about 10 wt % to about 99 wt % of the additional thermoplastic polyolefin.

16. The method of claim 10, wherein the main layer is a foaming layer or a leather layer.

17. The method of claim 10, wherein step (c) comprises providing an upper main layer and a lower main layer, and step (d) comprises applying an upper adhesive layer and a lower adhesive layer respectively to contact an unroughened upper surface and an unroughened lower surface of the modified polypropylene layer, and to adhere to the upper main layer and the lower main layer, such that the modified polypropylene layer is sandwiched between the upper main layer and the lower main layer.

18. The method of claim 10, wherein the adhesive layer includes thermoplastic resin.
